(19) United States
(12) Patent Application Publication
(10) Pub. No.: US 2007/0237883 A1
(43) Pub. Date: Oct. 11, 2007

(54) Method for processing meat

(75) Inventor: Hiroshi Mishima, Tokyo (JP)

Correspondence Address: BUCHANAN, INGERSOLL & ROONEY PC, POST OFFICE BOX 1404, ALEXANDRIA, VA, 22313-1404, US

(73) Assignee: Hiroshi Mishima, Tokyo (JP)

(21) Appl. No.: 11/730,054

(22) Filed: Mar. 29, 2007

(30) Foreign Application Priority Data
Apr. 11, 2006 (JP) 2006-108338
Mar. 7, 2007 (JP) 2007-56571

(51) Int. Cl. A23L 1/325

(52) U.S. Cl. 426/643

(57) ABSTRACT

A method of processing meat scarcely dripping upon defrosting and maintaining delicious taste, including a step of aging meats of fishes, edible birds, or animals while maintaining the temperature at the central portion from 1° C. to 8° C., a step of cutting, washing them, then a step of packing edible meat portions in vacuum, a step of preliminarily cooling them from −2° C. to 5° C. for 10 min to 60 min, and a step of quickly freezing the same to −18° C. or lower by liquid freezing

### BACKGROUND OF THE INVENTION

1. Field of the Invention

The present invention concerns a method of processing meat. Meat processed by the method of the invention scarcely drips upon defrosting.

2. Description of Related Art

Meats of fishes, edible birds or animals are distributed and traded in a frozen state and usually defrosted into commercial goods. Upon defrosting, a watery blood-stained liquid drips, which worsens the appearance as goods and, at the same time, delicious taste components are also released to result in remarkable deterioration of delicious tastes. Particularly, in frozen edible birds, there are scarce goods not dripping upon defrosting. Further, no literatures are found that suggest the method of overcoming such problems.

### SUMMARY OF THE INVENTION

The present inventors have made earnest studies on the method of processing meats scarcely dripping and, as a result, have accomplished the invention.

The method of processing meat according to the invention comprises aging meats of fishes, edible birds or animals while maintaining the temperature at the central portion thereof from 1° C. to 8° C., then cutting and washing them, packaging edible meat portions in vacuum, preliminarily cooling them from −2° C. to 5° C. for 10 to 60 min, and then quickly freezing the same to −18° C. or lower by liquid freezing.

In a case where the meat is a fish meat, it is aged while maintaining the temperature at the central portion from 1° C. to 8° C. for 3 hours to 20 hours.

In a case where the meat is of edible birds, it is aged while maintaining the temperature at the central portion from 1° C. to 8° C. for 6 hours to 72 hours.

Further, in a case where the meat is of animals, it is aged while maintaining the temperature at the central portion from 1° C. to 8° C. for 2 days to 24 days.

Meat processed by the method according to the invention scarcely drips upon defrosting and maintains delicious taste.

### PREFERRED EMBODIMENTS OF THE INVENTION

The method of processing meat according to the invention comprises aging meats of fishes, edible birds or animals while maintaining the temperature at the central portion thereof from 1° C. to 8° C., then cutting and washing them, packaging edible meat portions in vacuum, preliminarily cooling them to −2° C. to 5° C. for 10 to 60 min, and then quickly freezing the same from −18° C. or lower by liquid freezing.

In the invention, meat portions of fishes, edible birds or animals to be aged are previously processed as described below. In fishes, guts are removed. In animals, they are cut into legs, head, neck, etc. and removed with guts. As for edible birds, feathers are removed, legs, head and neck are cut off and guts are removed to be a carcass. The thus obtained meats of fishes, edible birds or animals are aged by maintaining the temperature at the central portion of the meat portions thereof from 1° C. to 8° C. The aging time is different depending on the kinds of fishes, edible birds, or animals and the time elapsed to the aging process. It is from 3 hours to 20 hours for fish meats, from 6 hours to 72 hours for edible birds, and from 2 days to 24 days for animals. In a case where the time keeping the temperature at 1° C. to 8° C. exceeds the time described above, it results in the deterioration (putrefaction, etc.) of meat quality irrespective of the kinds of fishes, edible birds, and animals. In a case where the aging time is shorter than the time described above, delicious tastes of meat after defrosting are lowered. Then, the aged fishes, edible birds or animals are cut and washed.

Then, the meat portions are packaged under vacuum, preliminarily cooled from −2° C. to 5° C. for 10 to 60 min and quickly frozen by liquid freezing to −18° C. or lower.

While the optimal temperature for the preliminary cooling somewhat differs depending on the kinds of fishes, edible birds, or animals, it is from −2 to 5° C. At a temperature higher than 5° C., even after quick-freezing, it results in a remarkable dripping phenomenon and greatly deteriorates the delicious tastes of meat during defrosting. In a case of cooling or freezing to lower than −2° C., the quality of meat changes remarkably and the dripping phenomenon can not be minimized.

For the quick-freezing, a method by a liquid quick-freezing is preferred. While a slow-freezing method requires about three hours even for 100 g of sliced raw fishes (sashimi), they can be frozen to −30° C. in about 40 min by the liquid quick-freezing. A cold air freezing method is not preferred since the freezing rate is slow and it takes much energy cost for maintaining the freshness and freezing the meats. Liquid quick-freezing is applied by using brine or ethanol. Brine is used in a case where an aimed temperature is about −20° C. Further, ethanol is used in a case where the freezing temperature is about −35° C. The aimed temperature for the quick-freezing can be determined properly depending on the kinds of fishes, edible birds and animals.

For the liquid quick-freezing, commercially available apparatus can be used. They include, for example, liquid freezer manufactured by Nakatani Shoko Co.

Meats put to vacuum packaging and quick-freezing are preserved in refrigerators, cold storage warehouses, etc. or they are shipped.

### EXAMPLE

The constitution of the present invention is to be described specifically by way of examples.

### Examples 1 to 7 and Comparative Examples 1 to 2

After slaughtering raised common pheasants, feathers were removed by an ordinary method and legs, heads, necks, and guts were removed. The thus obtained carcasses were aged being kept at a temperature of central portions for a time as shown in Table 1. Then, meats removed with bone were washed rapidly. They were portioned into small segments each of 200 g weight and packaged under vacuum and deaeration by a customary method to obtain 40 packs.

After preliminarily cooling vacuum packs at −1° C. to 5° C. for 15 min to 30 min by using chiller by liquid cooling, water content deposited to the pack surface was removed and they were put to quick-freezing using ethanol from −18° C. to −35° C. by using liquid freezer manufactured by Nakatani Shoko Co.

The quick-frozen vacuum packs were preserved at −18° C. or lower and the amount of drips upon defrosting was measured after one month, after 3 months, after 9 months, and after 12 months. The result is shown in Table 1. The amount of drips stands for percentage by weight.

TABLE 1

| | Tem- | | | | | |
|---|---|---|---|---|---|---|
| | perature | | Amount of drip (%) | | | |
| | for central | | After | After | | |
| | portion | time | one | 3 | After | After |
| | (° C.) | (hr) | month | months | 9 months | 12 months |
| Example 1 | 1 | 25 | 0.6 | 0.7 | 0.6 | 0.6 |
| Example 2 | 3 | 40 | 0.5 | 0.6 | 0.5 | 0.5 |
| Example 3 | 4 | 48 | 0.3 | 0.4 | 0.2 | 0.1 |
| Example 4 | 4 | 30 | 0.6 | 0.7 | 0.6 | 0.6 |
| Example 5 | 4 | 60 | 0.5 | 0.6 | 0.6 | 0.7 |
| Example 6 | 5 | 48 | 0.4 | 0.5 | 0.4 | 0.4 |
| Example 7 | 7 | 30 | 0.7 | 0.7 | 0.6 | 0.7 |
| Comp. | 9 | 48 | 0.8 | 0.9 | 1.0 | 0.7 |
| Example 1 | | | | | | |
| Comp. | 10 | 48 | 19.2 | 16.8 | 5.0 | 4.3 |
| Example 2 | | | | | | |

Pheasant meats obtained in Examples 1 to 7 and Comparative Examples 1 and 2 were roasted on charcoal and served for tasting by five men.

In Examples 1 to 7, the amount of drips was small and all the samplers evaluated that the pheasant meats maintained delicious tastes.

For Comparative Example 1, while the amount of drips was small, the meat quality was deteriorated and all the samplers evaluated that the delicious tastes were lost. For the pheasant meats of Comparative Example 2, since the amount of drips was large and deterioration of the meat quality was observed at a glance, tasting was not conducted.

### Example 8

In the same manner as in Example 1, raised common pheasants were packaged under vacuum and deaeration each into 200 g weight to obtain 40 packs. After preliminarily cooling them at 3° C. for 30 min under the same condition as in Example 1, they were put to quick-freezing with brine to −20° C. by using liquid freezer manufactured by Nakatani Shoko Co.

The quick-frozen vacuum packs were preserved at −18° C. or lower and the amount of drips was measured upon defrosting after one month, after 3 months, after 9 months, and after 12 months.

The amount of drips after one month, after 3 months, after 9 months, and after 12 months were 0.4%, 0.5%, 0.5%, and 0.6%, respectively.

### Example 9

Pacific sauries removed with guts were aged being kept at a temperature for the central portion of the inside thereof of 3° C. for 10 hours and washed rapidly. They were portioned into small segments each of 200 g weight and packaged under vacuum and deaeration by a customary method to obtain 8 packs. After preliminarily cooling under the same conditions as in Example 1, water content deposited on the surface of the vacuum packs was removed and they were put to quick-freezing to −20° C. with brine by using liquid freezer manufactured by Nakatani Shoko Co.

The quick-frozen vacuum packs were preserved at −18° C. or lower and the amount of drips upon defrosting after one month, after 3 months, after 9 months, and after 12 months was measured.

The amount of drips after one month, after 3 months, after 9 months, and after 12 months were 0.8%, 0.8%, 0.7%, and 0.8%, respectively.

### Comparative Example 3

Four vacuum packs of Pacific sauries were obtained in the same manner as in Example 9 except for keeping the Pacific sauries at a temperature for the central portion of 10° C. for 48 hours.

After preliminarily cooling them under the same conditions as those in Example 1, water content deposited on the surface of the vacuum pumps was removed and they were put to quick-freezing to −18° C. with brine by using liquid-freezer manufactured by Nakatani Shoko Co.

Quick-frozen vacuum packs were preserved at −18° C. or lower and the amount of drips was measured upon defrosting after one month, after 3 months, after 9 months, and after 12 months.

The amount of the drips after one month, after 3 months, after 9 months, and after 12 months were 9.0%, 10.4%, 10.5% and 10.2%, respectively.

### Example 10

Beefs obtained within three hours after slaughtering were aged being kept at a temperature for the central portion of 6° C. for one week.

They were portioned into small segments each of 200 g weight and packaged under vacuum and deaeration by a customary method to obtain 8 packs.

After preliminarily cooling them under the same conditions as those in Example 1, water content deposited on the surface of the vacuum packs was removed and they were put to quick-freezing to −35° C. with ethanol by using liquid freezer manufactured by Nakatani Shoko Co.

The quick-frozen vacuum packs were preserved at −18° C. or lower and the amount of drips upon defrosting after one month, after 3 months, after 9 months, and after 12 months were measured.

The amount of drips one month, after 3 months, after 9 months, and after 12 months were 0.5%, 0.4%, 0.5% and 0.4%, respectively.

### Comparative Example 4

For four vacuum packs of the beefs obtained in Example 10, water content deposited on the surface of the vacuum packs was removed under the same conditions as those in Example 10 and they were frozen to −35° C. by using a usual slow refrigerator.

The frozen vacuum packs were preserved at −18° C. or lower and the amounts of drips upon defrosting, after one month, after 3 months, after 9 months, and after 12 months were measured.

The amount of the drips after one month, after 3 months, after 9 months, and after 12 months were 7.5%, 9.2%, 8.8% and 9.5%, respectively.

What is claimed is:

1. A method of processing meat, comprising aging meats of fishes, edible birds or animals while maintaining the temperature at the central portion thereof from 1° C. to 8° C., then cutting and washing them, packaging meat portions in vacuum, preliminarily cooling them to −2° C. to 5° C. for 10 to 60 min, and then quickly-freezing the same to −18° C. or lower by liquid-freezing.

2. A method of processing meat according to claim 1, wherein the meat is a fish meat, which is aged while being maintained for 3 hours to 20 hours.

3. A method of processing meat according to claim 1, wherein the meat is a edible bird meat, which is aged while being maintained for 6 hours to 72 hours.

4. A method of processing meat according to claim 1, wherein the meat is an animal meat which is aged while being maintained for 2 days to 24 days.

5. A method of processing meat according to claim 3, wherein the edible bird is a bird belonging to the Phasianidae.
